(19) United States
(12) Patent Application Publication
(10) Pub. No.: US 2009/0123688 A1
(43) Pub. Date: May 14, 2009

(54) MOISTURE VAPOR PERMEABLE CARPET UNDERLAY

(76) Inventors: Ray W. Miller, Kennett Square, PA (US); Hari Babu Sunkara, Hockessin, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/937,371

(22) Filed: Nov. 8, 2007

(51) Int. Cl. B32B 33/00; B32B 27/00

(52) U.S. Cl. 428/95; 428/319.3; 428/317.7

(57) ABSTRACT

A carpet underlay that is liquid impermeable and moisture vapor permeable comprising a foamed cushion and a barrier film affixed to the side of the foamed cushion in contact with the carpet, the barrier film being impermeable to liquids and permeable to moisture vapor and comprising copolymer that comprises polytrimethylene ether soft segments and hard segments selected from the group consisting of polyester, polyamide, polyurethane and polyurethane-urea.

### FIELD OF THE INVENTION

The invention relates to a moisture vapor permeable carpet underlay.

### BACKGROUND

Water resistant carpet underlays provide a way to clean spills on carpet more thoroughly by helping to contain the spill above the padding or floor. If a spill is not removed from under the carpet, the spill will allow the growth of mold, mildew, and bacteria. Not only may the padding and wood flooring deteriorate as a result, but such conditions are conducive to the formation of odors and allergens. Spills on fitted or wall-to-wall carpeting are particularly insidious since detection and prevention of the seepage into the padding following a spill is typically impractical with large or fitted carpets. A spill on broadloom carpeting often puddles on the padding or flooring where it can not be removed by cleaning. This spill then accelerates the growth of mold, mildew and odors.

U.S. Pat. No. 5,601,910 and U.S. Pat. No. 5,763,040, describe processes for chemically treating an underlay with a repellent finish to make it substantially impermeable to spills. The underlay is adhered to the underside of the carpet creating a barrier substantially impervious to spills.

U.S. Pat. No. 6,253,526 discloses a process for installing a carpet underlay resistant to water requiring placing a padding over a floor, mechanically securing the padding to the floor and placing an underlay over the padding. The underlay is formed of a water resistant fabric or water resistant film. The fabric is treated with a water repellent finish.

WO2001/027382 A1 describes an underlay for a carpet having the desired properties of moisture vapor permeability, liquid impermeability and durability that is maintained under the pressure of cleaning.

U.S. Pat. No. 5,531,849 discloses a pad having a smooth polyurethane foam layer disposed between two film layers.

U.S. Pat. No. 6,872,445 describes a carpet pad comprising a two-layer structure of a cushion and a barrier film formed of a synthetic polymeric material free of any fibrous substrate laminated thereto.

US20040071927A1 discloses a carpet underlay comprising a composite of a fibrous substrate and a film affixed to the substrate which is impermeable to liquids and permeable to moisture vapor.

Conventional liquid impermeable carpet pads are made from ingredients derived from non-renewable fossil fuels. It would be a substantial advantage if an improved underlay material with water impermeability and moisture vapor permeability could be fabricated substantially from materials that are derived from renewable sources.

The present invention provides a renewable resource-based underlay with liquid impermeability, moisture vapor permeability and suitable flexibility and durability.

### SUMMARY OF THE INVENTION

One aspect of the present invention is a carpet underlay comprising: (a) a foamed cushion having opposite first and second planar sides and (b) at least one barrier film affixed to the first side of the foamed cushion, the barrier film being substantially impermeable to liquids and permeable to moisture vapor and comprising copolymer that comprises polytrimethylene ether soft segments and hard segments selected from the group consisting of polyester, polyamide, polyurethane and polyurethane-urea.

Another aspect of the present invention is a process for rendering a carpet or foamed carpet underlay cushion having an upper and a lower surface impermeable to liquids and permeable to moisture vapor, comprising providing a carpet having an underside; providing a cushion having an upper surface; and placing between the underside of the carpet and the upper surface of the cushion a barrier film that is impermeable to liquids and permeable to moisture vapor and that comprises copolymer comprising polytrimethylene ether segments and segments selected from the group consisting of polyester, polyamide, polyurethane and polyurethane-urea.

These and other aspects of the present invention will be apparent to one skilled in the art, in view of the following description and the appended claims.

### DETAILED DESCRIPTION OF THE PREFERRED EMBODIMENTS

This invention relates to a carpet underlay comprising: (a) a foamed cushion having opposite first and second planar sides and (b) at least one barrier film affixed to the first side of the foamed cushion the film being impermeable to liquids and permeable to moisture vapor and comprising copolymer that comprises polytrimethylene ether soft segments and hard segments selected from the group consisting of polyester, polyamide, polyurethane and polyurethane-urea.

In yet another aspect the invention relates to a process for rendering a carpet or foamed carpet underlay cushion having an upper and a lower surface impermeable to liquids and permeable to moisture vapor, comprising placing between the underside of the carpet and the upper surface of the cushion a barrier film that is impermeable to liquids and permeable to moisture vapor and that comprises copolymer comprising polytrimethylene ether segments and segments selected from the group consisting of polyester, polyamide, polyurethane and polyurethane-urea.

Preferably the carpet underlay is simultaneously impermeable to liquid deposited onto the underlay from above the barrier film, and permeable to moisture vapor at a moisture vapor transmission rate of at least 14.6 grams per square meter per twenty-four hours (14.6 g/m²/24 hours), the underlay being sufficiently durable to maintain liquid impermeability under a pressure of at least eight pounds per square inch (0.56 kg/m²) as measured by a Modified Mullen Bursting Strength Test, whereby the carpet underlay does not absorb liquid deposited onto the underlay from above the upper surface of the barrier film and allows moisture from below the lower surface of the cushion to pass through the underlay.

In a preferred aspect of the invention the carpet face yarn comprises fibers comprising polytrimethylene terephthalate. More preferably the carpet has a tufted yarn face and an underside, wherein the face yarn comprises polytrimethylene terephthalate fibers and the underside is affixed to the carpet underlay.

Preferably the foamed cushion comprises foamed polyurethane or polyurethane urea that comprises poly(trimethylene ether) blocks as a soft segment. The polyurethane or polyurethane-urea is preferably prepared from a reaction mixture comprising: (a) polytrimethylene ether glycol having a hydroxyl functionality greater than 2, preferably greater than 2 and less than about 4; and (b) diisocyanate. The reaction mixture may further comprise vegetable oil polyol preferably in an amount of from about 10 to about 90 weight % of the total amount of polyols. The reaction mixture may also further comprise polyisocyanate, a blowing agent and a chain extender.

In one embodiment, the barrier film preferably comprises polytrimethylene ether ester elastomer comprising from about 95 to about 5 weight % polytrimethylene ether ester soft segment and about 5 to about 95 weight % alkylene or phenylene ester hard segment. Preferably the hard segment comprises ester of at least one phenylene dicarboxylic acid selected from the group consisting of phthalic acid, isophthalic acid and terephthalic acid.

In another embodiment, the barrier film comprises from about 40 to about 90 weight % of polytrimethylene ether ester soft segment and about 10 to about 60 weight % polyamide hard segment. Preferably, the polyamide hard segments are joined by ester linkages to polytrimethylene ether soft segments prepared by reacting carboxyl terminated polyamide or diacid anhydride, diacid chloride or diester acid equivalents thereof and polyether glycol under conditions such that ester linkages are formed. More preferably, the carboxyl terminated polyamide is the polycondensation product of lactam, amino-acid or a combination thereof with dicarboxylic acid.

In yet another embodiment, the barrier film comprises block copolymer comprising polytrimethylene ether soft segments and polyurethane or polyurethane-urea hard segments. Preferably, the copolymer is a polyurethane or polyurethane-urea prepared from a reaction mixture comprising: (a) polytrimethylene ether glycol; (b) diisocyanate; and (c) diol or diamine chain extender.

Preferably the barrier film has a thickness in the range from about 0.5 to about 1.5 mils.

The carpet underlay can further comprise a layer of polymeric adhesive material bonding the barrier film to the upper surface of the cushion. Preferably the polymeric adhesive is a hot melt adhesive comprising copolymer that comprises polytrimethylene ether segments and segments selected from the group consisting of polyester, polyamide, polyurethane and polyurethane-urea.

Unless otherwise defined, all technical and scientific terms used herein have the same meaning as commonly understood by one of ordinary skill in the art to which this invention belongs. In case of conflict, the present specification, including definitions, will control.

Except where expressly noted, trademarks are shown in upper case.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Use of “a” or “an” are employed to describe elements and components of the invention. This is done merely for convenience and to give a general sense of the invention. This description should be read to include one or at least one and the singular also includes the plural unless it is obvious that it is meant otherwise.

The present invention comprises a carpet underlay comprising a foamed carpet cushion, and at least one barrier film affixed to one side of the foamed cushion. The film is impermeable to liquids and permeable to moisture vapor and comprises copolymer that comprises polytrimethylene ether soft segments and hard segments selected from the group consisting of polyester, polyamide, polyurethane and polyurethane-urea.

Important attributes of the underlay or impermeable barrier for carpets provided by the present invention are (1) the ability to keep the underlying carpet cushion and floor dry under a wide range of spills and cleaning techniques, and (2) the ability to prevent the retention of trapped moisture under the barrier by allowing it to evaporate promptly.

The term “breathable” denotes a moisture vapor transport rate of 14.6 g/m²/day or more, determined by the test method B described below.

The terms “permeable”, “vapor breathability”, and “air permeability” are used interchangeably with “breathable” herein.

The term “impermeable” signifies a “dry” rating under the conditions of Test Method 1 described below.

The terms “impermeable to liquids” and “permeable to moisture vapor” are used hereinafter to describe barrier films and carpet underlays that are impermeable (as defined above) to liquids, in particular water, but through which moisture vapor can readily permeate (in the context of the above definition).

The term “carpet cushion” as defined by The Carpet and Rug Institute (CRI), located in Dalton Ga., means any kind of material placed under carpet to provide resiliency, support, and noise reduction when walked upon (CRI 105 “Residential Carpet Installation Standards”).

The term “padding” or “pad” is considered synonymous with “carpet cushion”.

The carpet underlay comprises a foamed carpet cushion that is planar and has a first and second side. A barrier film is affixed to the first side of the cushion. Typically the carpet includes a pile face formed by tufting yarn into a carpet backing. The pile may be in either cut or looped form. In a normal installation the carpet is laid over the underlay such that the carpet backing is in contact with the barrier film and the second side of the cushion is then in contact with the floor.

Any of the conventional natural or synthetic fibers may be employed for the carpet pile face. A particularly preferred fiber is poly(trimethylene terephthalate). Poly(trimethylene terephthalate) fibers suitable for use in carpets are available from E.I. du Pont de Nemours and Company under the trade name SORONA® polymer fibers.

The barrier film between the carpet backing and the foamed cushion may optionally be bonded to the foamed cushion with a polymeric adhesive, preferably a hot melt adhesive, which does not substantially alter the liquid impermeability or moisture vapor permeability of the underlay.

A carpet underlay in accordance with this invention is both substantially impermeable to liquid deposited onto the pad from above the carpet (as from wetting caused by a liquid spill or animal wetting), and simultaneously permeable to moisture vapor transmitted through pad (“breathable”) from below (such as, for example, from moisture vapor from ordinary residential activity penetrating through the flooring below). “Impermeable to liquid” means that a liquid deposited onto the pad from above the barrier film does not enter into the cushion or pass through the pad. “Substantially impermeable”, as used herein, means at least 90% impermeable, preferably at least 95% impermeable, and even more preferably at least 98% impermeable. “Permeable to moisture vapor” means that moisture vapor is transmissible through the pad at a moisture vapor transmission rate of at least 14.6 grams per square meter per twenty-four hours (14.6 g/m²/24 hours). In this way, the pad is compatible with a floor surface that meets the recommended moisture vapor transmis.

In addition, the underlay is sufficiently durable to maintain liquid impermeability under a pressure of at least eight pounds per square inch (0.56 kg per square meter) as measured by the Modified Mullen Bursting Strength Test, to be described below. Durability may alternatively be expressed in terms of the ability of the pad to maintain liquid impermeability (as indicated by a stain/stain cleaning test) after Vetterman Drum Wear Test/Staining/Stain Cleaning Test of at least ten thousand cycles (10,000 cycles), as will also be described herein. As a result the carpet underlay does not absorb liquid deposited onto it from above the barrier film and allows moisture from below the lower surface of the cushion to pass through the underlay. The underlay is thus rendered less subject to odors related to moisture and bacterial growth.

### Barrier Film

The barrier film for use in the underlay is a copolymer that comprises polytrimethylene ether soft segments and hard segments selected from the group consisting of polyester, polyamide, polyurethane and polyurethane-urea.

With regard to copolymers comprising polytrimethylene ether soft segments and polyester hard segments, films suitable for use in the underlay are described in U.S. Patent Application Publication No. 2005/0282966. Particularly preferred films as disclosed in U.S. Patent Application Publication No. 2005/0282966 are based on copolymers comprising polyester hard segments prepared by reaction of 1,3-trimethylene glycol and terephthalic acid, esters of terephthalic acid, acid halides of terephthalic acid or acid anhydrides of terephthalic acid.

Copolymers comprising polytrimethylene ether soft segments and hard segments comprising polyamides that are suitable for preparing the barrier films are described in U.S. Pat. No. 6,590,065 and U.S. Pat. No. 6,979,492.

Copolymers comprising polytrimethylene ether soft segments and hard segments comprising polyurethane and/or polyurethane-ureas that are suitable for preparing the barrier films are described in U.S. Pat. No. 6,852,823 and U.S. Pat. No. 6,946,539.

Regardless of which barrier film composition is used, the film can be a cast film, an oriented film or a biaxially oriented film. Although thickness of the film is not a critical dimension so long as the film has the required liquid impermeability and moisture vapor permeability, preferred thickness is in the range of from about 0.5 to about 1.5 mils (0.0127 to 0.0381 cm). In addition, the barrier film should be sufficiently strong and resilient to resist rupture and to deform and recover repeatedly over its lifetime without adversely affecting its impermeability to liquids. Use of an appropriate barrier film results in the finished pad that exhibits the requisite ranges of liquid impermeability, moisture vapor permeability and durability.

The barrier film may be used as a free film and placed in contact with the carpet cushion; it may be laminated to the carpet cushion; or, it may bonded to the carpet cushion with a layer of adhesive, preferably a hot melt adhesive as discussed below.

The strength of the barrier film may be enhanced by use of a reinforcing structure disposed within the body of the film. The reinforcing structures may take the form of discrete threads or fibrils or a mesh structure that are formed within the body of the film during its manufacture.

### Carpet Cushion

The cushion is formed of a compressible resilient foamed material. The thickness of the cushion is selected to be consistent with considerations of cost, comfort and aesthetics for a given installation. Typically, the thickness dimension of the cushion lies in the range from 0.125 to 2 inches (0.3175 to 5 centimeters).

Any compressible and recoverable natural or synthetic foamed material may be used for the cushion. Suitable synthetic, non-cellulosic materials useful as the cushion include polyurethane or rubber continuous foams. Preferred materials for the cushion are polyurethane foams, and particularly preferred materials for the cushion are polyurethane or polyurethane-urea foams prepared from ingredients comprising polytrimethylene ether glycol or polyol and diisocyanate.

Polyurethane foam is produced by mixing diisocyanate, polyol, and water to create two simultaneous reactions: a gelling or polymerization reaction and a blowing or gas-producing reaction. The gelling reaction occurs when the isocyanate reacts with the polyol to form urethane chains. The blowing reaction occurs when the isocyanate reacts with the water to form carbon dioxide gas. Blowing can also be accomplished by the addition of organic blowing agents instead of or in addition to the use of water. The urethane chains make up the structure of the foam, while the carbon dioxide gas creates porosity within the foam by expanding the polyurethane polymer. Numerous additives may be mixed with the isocyanate, polyol, and water to control the rate and duration of the gelling and blowing reactions, while also providing a mechanism for urethane chain cross-linking and chain extension. When the gelling and blowing reactions are completed and the foam has had sufficient time to fully cure, the resulting polyurethane foam bun may be processed into various polyurethane foam products such as carpet underlay pads.

Polyurethane foams must be crosslinked in order to retain the foam structure. Consequently, the hydroxyl moieties need to have an average functionality greater than 2. Preferred polyurethane foams are prepared from reaction mixtures comprising polytrimethylene ether glycol and diisocyanate. Additional diols may be included as chain extenders. Polyurethanes of this type are discussed in U.S. Pat. No. 6,852,823.

Polytrimethylene ether glycol used in the manufacture of the foams is can be prepared by any process known to those skilled in the art. For example, it can be prepared by dehydration of 1,3-propanediol or by ring opening polymerization of oxetane. Preferred methods for making polytrimethylene ether glycol by acid catalyzed polycondensation of 1,3-propanediol are described in U.S. Pat. No. 6,720,459 and U.S. Pat. No. 6,977,291. For the purpose of the present invention the 1,3-propane diol used for making polytrimethylene ether glycol may contain small amount of polyols, e.g. glycerine, pentaerythritol, trimethylol propane, in order that the product might have an average hydroxyl functionality greater than 2. In this case it is preferred that the polytrimethylene ether glycol have an average hydroxyl functionality greater than 2 but less than about 4. For the purposes of this disclosure polytrimethylene ether glycol having an average hydroxyl functionality greater than 2 but less than about 4 prepared from 1,3-propanediol containing small amounts of polyols will be referred to as “polytrimethylene ether polyols”.

An alternative method of achieving an average hydroxyl functionality greater than 2 is to include in the reaction mixture for preparing the polyurethane foam a polyol or mixture of polyols in addition to polytrimethylene ether glycol. Any conventional isocyanate reactive polyol may be utilized. Typical examples are glycerine, pentaerythritol, trimethylol propane and vegetable oil polyols. Vegetable oil polyols are preferred. Polyurethane foams containing vegetable oil polyols are disclosed in U.S. Pat. No. 6,852,823. Polyols, when used will generally be used in an amount of from about 10 to about 90 weight % of the total amount of polyols and diols.

Typical diisocyanate for use in preparing the foams include, but are not restricted to toluene diisocyanate (TDI), diisocyanatodiphenyl methane (MDI), or blends thereof. One example of a suitable isocyanate is 80/20 TDI, which is a blend comprising 80 percent of the 2,4 isomer of TDI and 20 percent of the 2,6 isomer of TDI. Examples of other suitable isocyanates include: m-phenylene diisocyanate, p-phenylene diisocyanate, polymethylene polyphenyl-isocyanate, 2,4-toluene diisocyanate, 2,6-toluene diisocyanate, 4,4-diisocyanatodiphenyl methane, dianisidine diisocyanate, bitolylene diisocyanate, naphthalene-1,4-diisocyanate, diphenylene-4,4′-diisocyanate, xylylene-1,4-diisocyanate, xylylene-1,2-diisocyanate, xylylene-1,3-diisocyanate, bis(4-isocyanatophenyl)-methane, bis(3-methyl-4-isocyanatophenyl)-methane, 4,4-diphenylpropane diisocyanate, isophorone diisocyanate, hexamethylene diisocyanate, methylene-bis-cyclohexylisocyanate, and mixtures thereof.

### Polymeric Adhesive

As mentioned above, the barrier film between the carpet backing and the foamed cushion may optionally be bonded to the foamed cushion with a polymeric adhesive, preferably a hot melt adhesive, which does not substantially alter the liquid impermeability or moisture vapor permeability of the underlay. Hot melt adhesives will require an application temperature range that is low enough to avoid distortion of the barrier film.

Preferable the hot melt adhesives comprise copolymer that contains polytrimethylene ether soft segments and hard segments selected from the group consisting of polyester, polyamide, polyurethane and polyurethane-urea. Copolymers useful as adhesives are those copolymers useful in the barrier film, disclosed hereinabove.

A preferred hot melt adhesive type is that disclosed in U.S. Pat. No. 5,660,887. The patent discloses polyurethane hot melt adhesives that are hardened by the action of moisture and which contain at least one reaction product from a component that contains isocyanate groups and an essentially linear hydroxypolyester, hydroxypolyether, and/or hydroxypolyetherester component. The adhesives are disclosed as being water-vapor permeable. For the purposes of the present invention it is highly preferred for the hydroxypolyester, hydroxypolyether, and/or hydroxypolyetherester components to be prepared utilizing 1,3-propanediol and/or polytrimethylene ether glycol instead of ethylene glycol or polyethylene glycol as illustrated in U.S. Pat. No. 5,660,887.

The carpet underlays can be prepared in any of several ways: by placing a separate barrier film in contact with the foamed cushion, by laminating the barrier film to the cushion or by adhering the barrier film to the cushion with adhesive as discussed above.

An underlay in accordance with this invention is both impermeable to liquid deposited onto the pad from above the carpet (as from wetting caused by a liquid spill or animal wetting) and is simultaneously permeable to moisture vapor transmitted through the underlay (“breathable”) from below (as from moisture vapor from ordinary residential activity penetrating through the flooring below). “Impermeable to liquid” means that a liquid deposited onto the underlay from above the barrier film does not enter into the cushion or pass through the underlay. “Permeable to moisture vapor” means that moisture vapor is transmissible through the pad at a moisture vapor transmission rate of at least 14.6 grams per square meter per twenty-four hours (14.6 g/m²/24 hours). Thus, the underlay is compatible with a floor surface that meets the recommended moisture vapor transmission standard promulgated by the Carpet and Rug Institute.

In addition, the underlay is sufficiently durable to maintain liquid impermeability under a pressure of at least eight pounds per square inch (0.56 kg per square meter) as measured by the Modified Mullen Bursting Strength Test, to be described. Durability may alternatively be expressed in terms of the ability of the pad to maintain liquid impermeability (as indicated by a stain/stain cleaning test) after a Vetterman Drum Wear Test/Staining/Stain Cleaning Test of at least ten thousand cycles (10,000 cycles), as will also be described herein. As a result the underlay does not absorb liquid deposited onto the pad from above the barrier film and allows moisture from below the lower surface of the cushion to pass through. The underlay is thus rendered less subject to odors related to moisture and bacterial growth.

The carpet underlays may be used in conjunction with any type of conventional carpets, in particular with those containing tufted face yarns. Any of the common natural or synthetic face yarns may be utilized. A particularly preferred fiber is poly(trimethylene terephthalate). Poly(trimethylene terephthalate) fibers suitable for use in carpets are available, for example, from E.I. du Pont de Nemours and Company under the trade name SORONA® polymer fibers.

Carpet systems comprising poly(trimethylene terephthalate) face yarns and a carpet underlay as disclosed herein have a substantial advantage over other commonly used systems in that they are based in part on 1,3-propanediol, which is available biochemically from a renewable source (“biologically-derived” 1,3-propanediol). Other systems known in the art are based totally on non-renewable petroleum derived raw materials.

A particularly preferred source of 1,3-propanediol is via a fermentation process using a renewable biological source. As an illustrative example of a starting material from a renewable source, biochemical routes to 1,3-propanediol (PDO) have been described that utilize feedstocks produced from biological and renewable resources such as corn feed stock. For example, bacterial strains able to convert glycerol into 1,3-propanediol are found in the species Klebsiella, Citrobacter, Clostridium, and Lactobacillus. The technique is disclosed in several publications, including U.S. Pat. No. 5,633,362, U.S. Pat. No. 5,686,276 and U.S. Pat. No. 5,821,092. U.S. Pat. No. 5,821,092 discloses, inter alia, a process for the biological production of 1,3-propanediol from glycerol using recombinant organisms. The process incorporates E. coli bacteria, transformed with a heterologous pdu diol dehydratase gene, having specificity for 1,2-propanediol. The transformed E. coli is grown in the presence of glycerol as a carbon source and 1,3-propanediol is isolated from the growth media. Since both bacteria and yeasts can convert glucose (e.g., corn sugar) or other carbohydrates to glycerol, the processes disclosed in these publications provide a rapid, inexpensive and environmentally responsible source of 1,3-propanediol monomer.

The biologically-derived 1,3-propanediol, such as produced by the processes described and referenced above, contains carbon from the atmospheric carbon dioxide incorporated by plants, which compose the feedstock for the production of the 1,3-propanediol. In this way, the materials based on biologically-derived 1,3-propanediol contain a substantial level of renewable carbon instead of fossil fuel-based or petroleum-based carbon. Materials based on biologically-derived 1,3-propanediol, therefore, have less impact on the environment because the 1,3-propanediol used does not deplete diminishing fossil fuels and, upon degradation, releases carbon back to the atmosphere for use by plants once again. Thus, the compositions disclosed herein for use in making the underlays can be characterized as more natural and having less environmental impact than similar compositions comprising petroleum based diols.

### Test Methods

A. Moisture Vapor Transmission Rate Test: The permeability to moisture vapor is measured using a moisture vapor transmission rate test. A sample of a pad is mounted in the lip of a cup, which contains water. The underlay is mounted such that the lower surface of the cushion is presented to the water. The entire assembly is weighed. An air flow of one hundred fifty (150) meters/minute [approximately five hundred (500) feet per minute] is caused to pass continuously over the exposed (upper) surface of the underlay in an environment controlled to 25° C. and 55% relative humidity for an interval of 24 hrs±15) minutes. The assembly is re-weighed and the weight loss of the specimen determined. The moisture vapor transmission rate (MVTR) is calculated as the weight difference of the assembly in grams divided by the area of the sample in meters.

The described method is a modification of ASTM E-96 (14.1) except that twenty-four hour exposure is employed rather than attempting to measure a time rate to achieve steady state so that the results of this test method will be more directly comparable to the moisture vapor transmission standards of the Carpet and Rug Institute.

B. Water Impermeability: A 5-layer test stack is prepared as follows: (1) A sample of residential carpeting with water permeable, latex is placed over (2) the underlay sample which is in turn placed on (3) a white absorbent paper towel placed over (4) rebond carpet padding which is placed over (5) a wood particle board sheet.

The paper towels used are single-fold paper towels available from Kimberly-Clark, Dallas Tex. Since the test requires no visible wetness of the towel, the choice of paper towel is not critical and other thin absorbent media, such as Whatman No. 1 Filter paper may be substituted. A colored aqueous solution may be used to aid visual detection. Then 100 ml of water, at a room temperature of 24±3° C. is slowly poured onto the carpet sample through a cylinder of about 8 cm diameter and from a height of about 1 meter to create a circular puddle. The cylinder is removed and the sample is left undisturbed for 20 minutes. For the 0 psi (0 kPa, i.e. spill only test) the carpet and underlay are removed. If any water spot is visible on the towel (designated “wet” in the results), then the underlay is judged a failure to provide sufficient water impermeability to a water spill. If the paper towel between the padding and carpet was dry (designated “dry” in the results), the underlay is judged acceptable and provided sufficient water impermeability to a water spill. Alternatively, the water is “blotted” from the carpet pile with dry paper towels at a given pressure. After ten “blottings” with the given pressure, the carpet and underlay are removed. If any water spot is visible on the towel, then the underlay is judged a failure (or “wet”) and did not provide sufficient water impermeability for a water spill followed by blotting at the given pressure. If the paper towel between the padding and carpet is “dry”, the underlay is judged to provide sufficient water impermeability for a water spill followed by blotting at the given pressure. Blotting pressures of 0, 3, 8, 16, and 33 psi (0, 21, 55, 110, and 227 kPa) are utilized. A blotting pressure of 33 psi or 228 kPa exceeds the pressure exerted by a typical homeowner standing on a paper towel to accelerate the blotting of a spill. The blotting pressures are created by placing weights on a circular disc as follows:

C. Modified Mullen Bursting Strength Test (“Modified Mullen Test”): The durability of the underlay to maintain liquid impermeability is measured using a test that is a modification of the Diaphragm Bursting Strength Test Method (ASTM D-3786-87) using a Modified Mullen Model HA tester available from B. F. Perkins, Inc., Chicopee, Mass., or equivalent. The testing apparatus comprises a pressure cylinder open on one end to the atmosphere and connected to a water reservoir and hydraulic gage. The other end of the pressure cylinder has a piston, which can be advanced by a motor drive to compress any water in the chamber. A valve is provided on the water reservoir as a convenience in filling the chamber and also to prevent reverse flow of the water back into the reservoir. A sample is mounted in a test ring that is clamped securely at the mouth of the pressure cylinder with the upper side of the underlay (which would in use contact the bottom of the carpet) presented to the pressure cylinder. Water pressure is then applied to the sample and the value of the pressure at which water is observed to break through the sample is noted. A low value under six to 6-8 psi (approximately 0.4-0.6 kg/cm²) indicates that the pad is not likely to maintain liquid impermeability under normal household spot cleaning by hand.

D. Vetterman Drum Wear Test/Staining/Stain Cleaning Test.: The durability of an underlay to maintain liquid impermeability is also measured using a Vetterman Drum Wear Test followed by a Staining/Stain Cleaning test. This test measures the durability of an underlay to maintain liquid impermeability after wear.

1. Vetterman Drum Wear Test: A Vetterman Drum Wear test in accordance with ASTM-D-5417 closely correlates to floor trafficking. This test is conducted in a Vetterman drum test apparatus, Type KSG, manufactured by Schoenber & Company, Bauber, Federal Republic of Germany, according to the International Standards Organization (ISO) document TC38/12/WG 6 N 48. As specified in the standard the drum is lined with a thirty-five ounce (35 oz, 2.1875 kg.) cut pile residential saxony carpet and a test sample of carpet underlay is disposed underneath the carpet. A 16 pound steel ball having 14 rubber buffers is placed on the top of the carpet and is allowed to roll randomly inside the rotating drum. A circular brush within the drum is in light contact with the carpet pile surface and picks up loose fuzz of or fibers, which are continuously removed by suction.

After 10,000 cycles in the Vetterman drum test apparatus the test pad sample is removed and further tested using the “Stain Cleaning Test” as outlined below.

2. Stain Cleaning Test: After 10,000 cycles in the Vetterman drum test apparatus the carpet pad sample is stained 24 hours using the “Staining Test” procedure followed by the “Stain Cleaning Test (With Hand Pressure)” procedure.

a. “Staining Test” Procedure: A staining solution of 45 grams of a cherry flavored, sugar sweetened, Kool-Aid brand powder drink mix is mixed in 500 ml of water. The solution is allowed to reach room temperature before use. A white absorbent paper towel or blotter paper is placed beneath the cushioning layer (bottom layer) of a test sample carpet underlay approximately 6 in square (approximately 15 cm square. Twenty milliliters (20 ml) of the staining solution are poured onto the top surface of the test sample of the underlay through a 1½″ diameter cylinder from a height of about 3 cm to create a circular stain on the top surface of the underlay. The cylinder is removed and the staining solution is mechanically worked onto the underlay, e.g., by hand, to obtain uniform staining. The underlay is allowed to stay undisturbed for 24 hours.

b. “Staining Cleaning Test (With Hand Pressure)” Procedure: At the end of the 24 hour period of the “Staining Test Procedure” any remaining staining solution on the upper surface of the test sample carpet underlay is blotted with an absorbent white paper towel. A mild detergent cleaning solution is prepared by diluting 5 ml of a commercially available liquid “Tide”-brand detergent in 95 ml of water. Ten milliliters (10 ml) of the detergent cleaning solution is poured onto the stained area of the test pad surface through a 1½″ diameter cylinder from the height of about 3 cm. The cylinder is removed and the cleaning solution is mechanically worked onto the pad, e.g., by hand, over the stained area to remove the stain. The excess cleaning solution is blotted with an absorbent white paper towel. Approximately 10 ml of water is then poured onto the stained area of the surface of the test pad through a 1½″ diameter cylinder from the height of about 3 cm. The cylinder is removed and the water is blotted using white absorbent paper towel with 3 clockwise and 3 counter-clockwise hand circular motions with an estimated pressure of about 6-8 psi (approximately 0.4-0.6 kg/cm²) to simulate normal household spot cleaning by hand. The applied pressure can be measured by placing a scale underneath the sample to determine the total applied pressure (in pounds) and dividing by the area of contact with the cleaning surface (in square inches). The sample underlay is lifted and the white absorbent paper is examined for visual red staining. If a considerable amount of the staining solution has passed through the test sample of the pad a severe stain will be visible on the white absorbent towel or blotter paper (“STAIN”, i.e., fails the test). The sample pad will be termed as “substantially impervious” (“NO STAIN”, i.e., passes the test) if none or a very slight amount of staining solution has passed through the test sample of the pad, leaving none or a few visible drops of stain on the white absorbent towel or blotter paper.

What is claimed is:

1. A carpet underlay comprising:
(a) a foamed cushion having opposite first and second planar sides; and
(b) at least one barrier film affixed to the first side of the foamed cushion, the barrier film being substantially impermeable to liquids and permeable to moisture vapor and comprising copolymer that comprises polytrimethylene ether soft segments and hard segments selected from the group consisting of polyester, polyamide, polyurethane and polyurethane-urea.

2. The carpet underlay of claim 1 wherein the foamed cushion comprises foamed polyurethane, or polyurethane urea comprising poly(trimethylene ether) blocks as a soft segment.

3. The carpet underlay of claim 1 wherein the barrier film comprises polytrimethylene ether ester elastomer comprising from about 80 to about 5 weight % polytrimethylene ether ester soft segment and about 20 to about 95 weight % alkylene or phenylene ester hard segment.

4. The carpet underlay of claim 3 wherein the hard segment comprises an ester of at least one dicarboxylic acid selected from the group consisting of phthalic acid, isophthalic acid and terephthalic acid.

5. The carpet underlay of claim 1 wherein the barrier film comprises from about 40 to about 80 weight % of polytrimethylene ether ester soft segment and about 20 to about 60 weight % polyamide hard segment.

6. The carpet underlay of claim 5 wherein the polyamide hard segments are joined by ester linkages to polytrimethylene ether soft segments prepared by reacting carboxyl terminated polyamide or diacid anhydride, diacid chloride or diester acid equivalents thereof and polyether glycol under conditions such that ester linkages are formed.

7. The carpet underlay of claim 6 wherein the carboxyl terminated polyamide is the polycondensation product of lactam, amino-acid or a combination thereof with dicarboxylic acid.

8. The carpet underlay of claim 1 wherein the barrier film comprises copolymer comprising polytrimethylene ether soft segments and polyurethane or polyurethane-urea hard segments.

9. The carpet underlay of claim 8 wherein the copolymer is a polyurethane or polyurethane-urea prepared from a reaction mixture comprising: (a) polytrimethylene ether glycol; (b) diisocyanate; and (c) diol or diamine chain extender.

10. The carpet underlay of claim 1 that is simultaneously impermeable to liquid deposited onto the underlay from above the barrier film, and permeable to moisture vapor at a moisture vapor transmission rate of at least 14.6 grams per square meter per twenty-four hours (14.6 g/m²/24 hours), the underlay being sufficiently durable to maintain liquid impermeability under a pressure of at least eight pounds per square inch (0.56 kg/m²) as measured by a Modified Mullen Bursting Strength Test, and wherein the carpet underlay does not absorb liquid deposited onto the underlay from above the upper surface of the barrier film and allows moisture from below the lower surface of the cushion to pass through the underlay.

11. The carpet underlay of claim 1 further comprising a layer of polymeric adhesive material bonding the barrier film to the upper surface of the cushion.

12. The carpet underlay of claim 11 that is simultaneously impermeable to liquid deposited onto the underlay from above the barrier film, and permeable to moisture vapor at a moisture vapor transmission rate of at least 14.6 grams per square meter per twenty-four hours (14.6 g/m²/24 hours), the underlay being sufficiently durable to maintain liquid impermeability under a pressure of at least eight pounds per square inch (0.56 kg/m²) as measured by a Modified Mullen Bursting Strength Test, whereby the carpet underlay does not absorb liquid deposited onto the underlay from above the upper surface of the barrier film and allows moisture from below the lower surface of the cushion to pass through the underlay.

13. The carpet underlay of claim 11 wherein the polymeric adhesive is a hot melt adhesive comprising copolymer that comprises polytrimethylene ether soft segments and hard segments selected from the group consisting of polyester, polyamide, polyurethane and polyurethane-urea.

14. The carpet underlay of claim 13 wherein the hard segment comprises an ester of at least one dicarboxylic acid selected from the group consisting of phthalic acid, isophthalic acid and terephthalic acid.

15. The carpet underlay of claim 13 wherein the polyamide hard segments are joined by ester linkages to polytrimethylene ether soft segments prepared by reacting carboxyl terminated polyamide or diacid anhydride, diacid chloride or diester acid equivalents thereof and polyether glycol under conditions such that ester linkages are formed.

16. The carpet underlay of claim 13 wherein the copolymer is a polyurethane or polyurethane-urea prepared from a reaction mixture comprising: (a) polytrimethylene ether glycol; (b) polyisocyanate; and (c) diol or diamine chain extender.

17. The carpet underlay of claim 2 wherein the foamed polyurethane or polyurethane urea is prepared from a reaction mixture comprising: (a) polytrimethylene ether glycol (b) polyisocyanate and (c) blowing agent.

18. The carpet underlay of claim 17 wherein the reaction mixture further comprises vegetable oil polyol.

19. The carpet underlay of claim 18 wherein the amount of vegetable oil polyol is from about 10 to about 90 weight % of the total amount of polyols.

20. Carpet having a tufted yarn face and an underside, wherein the yarn face comprises polytrimethylene terephthalate fibers and the underside is affixed to the carpet underlay of claim 1.

21. A process for rendering a carpet or foamed carpet underlay cushion having an upper and a lower surface impermeable to liquids and permeable to moisture vapor, comprising providing a carpet having an underside; providing a cushion having an upper surface; and placing between the underside of the carpet and the upper surface of the cushion a barrier film that is impermeable to liquids and permeable to moisture vapor and that comprises copolymer comprising polytrimethylene ether segments and segments selected from the group consisting of polyester, polyamide, polyurethane and polyurethane-urea.

22. The process of claim 21 wherein the barrier film has a thickness in the range from about 0.5 to about 1.5 mils.

23. The process of claim 21 wherein the barrier film is bonded to the upper surface of the cushion with a layer of polymeric adhesive.

24. The process of claim 21 wherein the foamed cushion comprises foamed polyurethane or polyurethane urea comprising poly(trimethylene ether) blocks as a soft segment.

25. The process of claim 21 wherein the carpet face yarn comprises fibers comprising polytrimethylene terephthalate.
